(19) United States
(12) Patent Application Publication
(10) Pub. No.: US 2017/0373996 A1
(43) Pub. Date: Dec. 28, 2017

(54) SYSTEMS AND METHODS FOR AUTOMATIC MESSAGE TAGGING ON MOBILE DEVICES

(71) Applicants: Mohammed Vahid Danesh-Bahreini, Bellevue, WA (US); Kaveh Danesh, Bellevue, WA (US); Bahareh Danesh-Bahreini, Bellevue, WA (US)

(72) Inventors: Mohammed Vahid Danesh-Bahreini, Bellevue, WA (US); Kaveh Danesh, Bellevue, WA (US); Bahareh Danesh-Bahreini, Bellevue, WA (US)

(21) Appl. No.: 15/632,148

(22) Filed: Jun. 23, 2017

Related U.S. Application Data
(60) Provisional application No. 62/354,544, filed on Jun. 24, 2016.

(51) Int. Cl. H04L 12/58; G06Q 50/00; G06F 17/30

(52) U.S. Cl. CPC H04L 51/046; G06F 17/30014; G06Q 50/01

(57) ABSTRACT

Systems and methods are disclosed including a computing device having a tag-sharing app (small mobile software application) configured to run on the computing device and to communicate with a user of the mobile device, a tag-sharing website, and a tag-sharing database. The user enrolled in the tag-sharing program may select one or more images, such as a profile picture, a logo image, and/or the like, to tag (be included in) one or more of his text messages. In some embodiments, the tag includes a hotlink that connects to a website associated with the image and provides further information associated with the image. In some embodiments, special opportunities associated with a business associated with the image may be provided via the hyperlink.

### CROSS-REFERENCE TO RELATED APPLICATION

This application claims the benefit of Provisional Application No. 62/354,544, filed Jun. 24, 2016, which is hereby incorporated by reference herein in its entirety for all purposes.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a communication system comprising a computer network and a mobile computing device is provided. The mobile computing device is coupled with the computer network and has a tag-sharing app running thereon. The mobile computing device is configured to tag a message transmitted by the mobile computing device with an image and a hotlink to a webpage.

In some embodiments, a method of communication is provided. A tag-sharing app is executed on a mobile computing device. The tag sharing app is configured to implement a tagging policy. The tagging policy is applied by the tag-sharing app to tag an outgoing message from the mobile computing device with an image and a hotlink to a webpage to present information.

In some embodiments, a method of tagging outgoing messages is provided. A tag-sharing app is executed on a mobile computing device. A tag is selected that includes an image and a hotlink. The tag-sharing app is configured to implement a tagging policy to include the tag in an outgoing message. The tagging policy is applied by the tag-sharing app to include the tag in the outgoing message from the mobile computing device.

### DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example message communication environment usable for dynamic message tagging;

FIG. 4 shows an example mobile computing device with a text messaging application usable in the computing environment of FIG. 3;

FIG. 5 shows an example message of the text messaging application of FIG. 4 tagged with an image and a hotlink; and

FIG. 6 shows an example tag sharing application on a mobile device configured to interact with a user and display the user's tag usage status.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references particular mobile devices such as smart phones, the disclosures may be applicable to other devices such as tablets, laptops, and desktop computers, and the like.

Briefly described, systems and methods are disclosed including a computing device having a tag-sharing app (small mobile software application) configured to run on the computing device and communicate with a user of the mobile device, a tag-sharing website, and a tag-sharing database. The tag-sharing website is configured to interact with the user for enrollment or registration in a tag-sharing program, selection of desired images, and other setup operations. The tag-sharing database may be used to store data related to the user tag-sharing activities, user profiles, and other similar data. The user enrolled in the tag-sharing program may select one or more images, such as a profile picture, a logo image, and/or the like, to tag (be included in) one or more of his text messages. In some embodiments, the tag includes a hotlink that connects to a website associated with the image and provides further information associated with the image. In some embodiments, special opportunities associated with a business associated with the image may be provided via the hyperlink. The user or the recipient may use the hotlink. The user may earn credits or tokens and ranking points based on his level of usage of tagged messages, and/or based on a number of click-throughs by recipients on the hotlink sent by the user.

With the ubiquity of users' internet access there has been an ever increasing demand for expanded services, functionality, online storage, sharing capabilities, and the like. Commensurate with this increase in demand, there has been an explosion of information and communication platforms, which ironically has made it harder for users to seamlessly share images along with the transmission of text messages. What is desired are techniques for improving the ability to automatically associate images with text message, and to automatically track and encourage such automatic association.

Illustrative Operating Environment

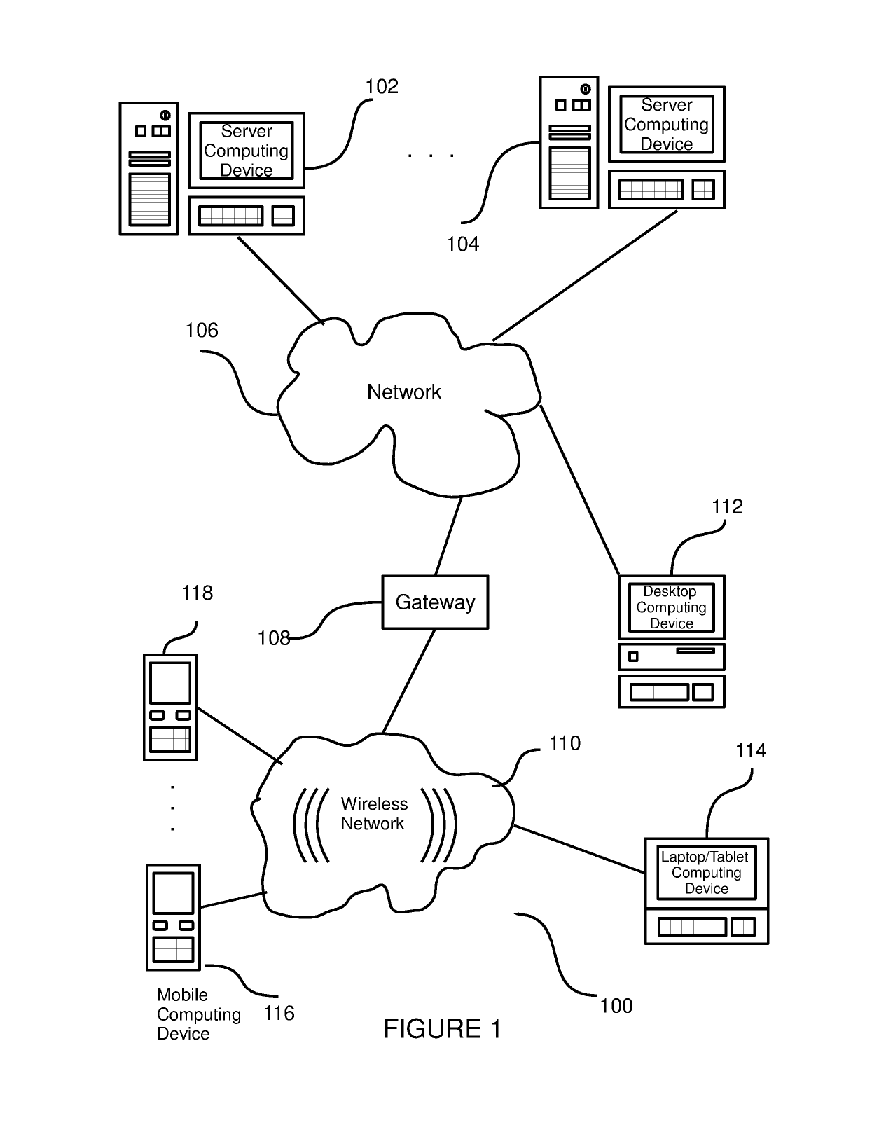

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

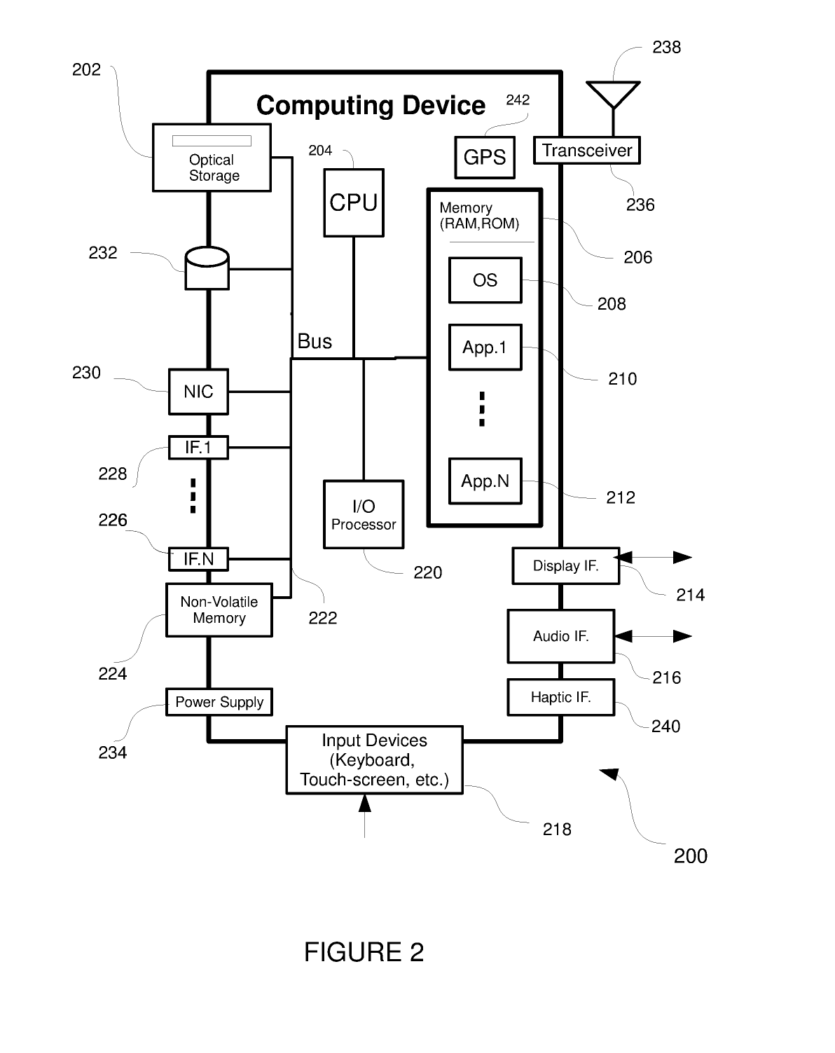

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), and/or the like, to display and send information.

Client computing devices 112-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, send/receive SMS messages, send/receive proprietary platform messages (such as Facebook Messages, WhatsApp messages, iMessage messages, and/or the like), access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including but not limited to 2G, 3G, 4G, and LTE radio access for mobile wireless systems, WLAN, Wireless Router (WR) mesh, and the like. Access technologies such as 2G, 3G, 4G, and the like may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, Bluetooth Low Energy (LE), High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs and/or software modules/components 210-212. Such software modules and components may be stand-alone application software or be components, such as DLL (Dynamic Link Library) of a bigger application software. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC (Media Access Control) address.

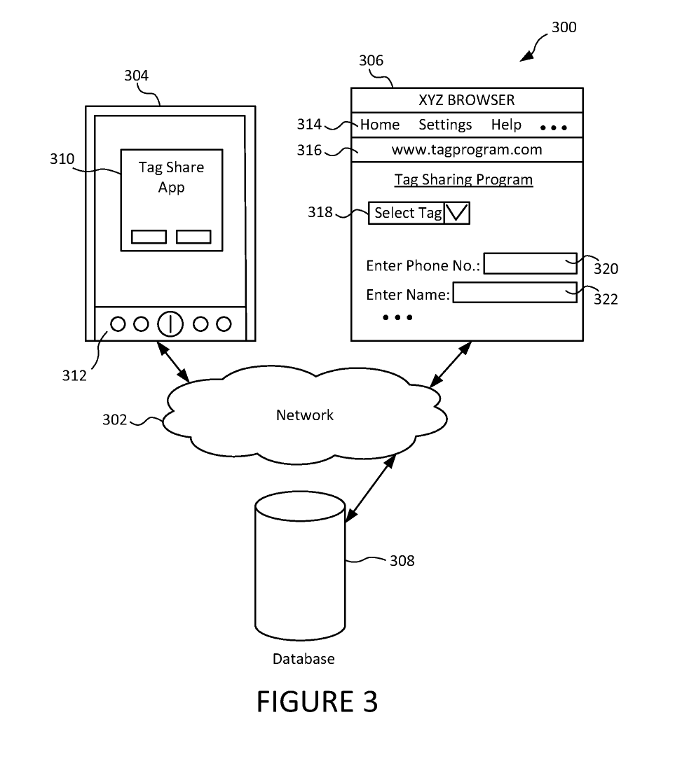

FIG. 3 shows an example message communication environment usable for dynamic message tagging. In various embodiments, message communication environment 300 includes a computer network 302, a mobile computing device 304, a website 306 running on a webserver, and a database system 308, all coupled together via the computer network. The mobile computing device may include various hardware control buttons 312 and various apps 310 running on it. The website may include a menu bar 314 providing various functions, an address or Uniform Resource Locator (URL) bar 316, user interface elements 318, 320, and 322 for obtaining user information regarding tag selection, mobile phone number, and user name, date of birth, address, hobbies, travel hot spots, outdoor activities, electronics preferences, clothing retailer preferences, (specifically a list of questions pertaining to the user shopping habits, favorite retailers and shopping needs) respectively, among other web-based functions and elements.

In various embodiments, the computer network 302 may be the Internet or other private or public computer network suitable for sending digital data, including instant messages or text messages.

In various embodiments, the mobile computing device 304 is substantially similar in function to the computing devices shown in FIGS. 1 and 2. The mobile computing device may be a smart phone, a tablet computer, a laptop computer, a PDA (Personal Digital Assistant) or any other computing device capable of sending and receiving messages. The mobile computing device 304 may include various apps for various functions such as playing music, playing games, weather report, utility software like calculators and camera, and the like. One such app may be a tag-sharing app that may be downloaded for free or for a fee to assist the user in inserting, deleting, positioning, and generally managing tags that include images and hotlinks to be automatically included within one or more messages in a conversation. In some embodiments, the tag-sharing software may actually be a webpage loaded onto the mobile computing device where most of its data processing takes place on a remote webserver, while in other embodiments, it may be a locally loaded and executed app.

In various embodiments, the tag-sharing app may be set up by the user to automatically tag (include in) one or more text messages with a selected image and hotlink. For example, the user may set up the tag-sharing app to tag only the first message in a text-based conversation, or tag the first few. In other embodiments, the tag-sharing app may include a default policy or algorithm on how to tag messages. In some embodiments, the tag-sharing app may include setup menus or similar user interface to configure how messages are tagged (tagging policy). The tagging policies may include tagging only the first message in a conversation, the first N messages in a conversation, every message in a conversation, tag a message after each predetermined number of messages in the same conversation, tag a message after each predetermined number of time units (e.g., minutes, hours, days, etc.) in the same conversation, and the like. Tags may be configured to only be sent to individuals listed on the mobile or desktop device list of contacts or directory. This can help prevent the user from sending tagged messages out to random mobile numbers to gain tokens as described below.

In some embodiments, the tag-sharing app may be set up to switch tags and use different images for different messages based on some criteria, such as time, message count, day of week, recipient of the message, a prioritized list of tags to be used in order, a predetermined schedule of tags to be used, and the like. This mobile device-side tag-sharing software may also implement some or all of the functions provided by the website 306, as further described below. In some embodiments, the user may select an image associated with a retailer, that is uploaded by the retailer via a retailer portal. Thereafter, the retailer may change the image, or may add a new hotlink of a coupon, brand, or a URL to a particular section of their website using the retailer portal, and the updated information will be automatically downloaded by the tag-sharing app to be used in subsequent tags.

In various embodiments, the tag-sharing app may be configured to tag other various message or communication types such as email, instant messaging, or social media postings. The configuration of the tag-sharing app to apply to different message types, may also necessitate the changing of tagging policies to be consistent with the selected message type. For example, if the tagging is to be applied to a Facebook posting (instead of a text message) then the concept of a conversation may not be relevant and each posting, or every other posting, or some postings based on various criteria (such as time, day of week, subject, most contacted or interactive friends, etc.) may be tagged with an image and hotlink.

In various embodiments, an image included in a text message may be accompanied with a text segment, such as a name or a tagline or phrase, which is also a hotlink that when selected downloads a webpage associated with the image. In other embodiments, the image may itself be a hotlink directed to a web page that describes information related to the image, such as special offers, coupons, or discount for goods or services. Such offers may be based on the user's profile, including age, sex, purchase histories, circle of close friends and contacts as determined from frequency and length of messaging interactions, and the like.

In some embodiments, the tag-sharing app may change the hotlink to lead to different webpages and different information depending on the recipient of the text message. More specifically, if the message recipient is a known user of the tag-sharing program and has a profile in the database, then the images and hotlinks sent to him via text messages by other users who are also enrolled in the tag-sharing program, then the hotlink included in the sender's text message may be tailored based on the profile of the recipient, such as age and sex. The tag-sharing app may acquire profile information from the database 308 dynamically in real-time when the text message is being composed by the sender. For example, if the recipient of a message is a 14-year old male, then the hotlink may lead to a video game page with special promotions, while if the recipient is 45-year old female, the hotlink may lead to a vacation package or clothing sale webpage.

In various embodiments, the tag-sharing app may collect usage data from other activities of the user on various websites, social networks, online purchases, time of day rate of activities, and profiles for the same user from other sources to build or update the tag-sharing user profile by aggregating and storing this data in the database. The same user profile may subsequently be used to determine what images and hotlinks to include in the next text message or email of the user.

In various embodiments, the tag-sharing app may include a different software component for each distinct function. One or more functions may be performed by each software component recorded on a medium such as a USB disk, optical disk, volatile or non-volatile computer memory, and the like, or transmitted by various communication techniques using various network and/or communication protocols, as described above with respect to FIG. 1. For example one or more separate software components may be used for each of the functions in the system such as collecting data from the user, interacting with the database, setup, user profile creation and/or update, user account creation and/or update, tagging messages, user interface, tagging policy (as described herein) implementation, counting and accounting for points and credits/tokens, notification of user of various events such as promotions and credit awards, managing user promotion, and the like. Those skilled in the art will appreciate that one function may be implemented using multiple software modules or several functions may be implemented using one software module. With further reference to FIG. 2, these software modules are generally loaded into the memory module 206 of the computing device for execution.

In various embodiments, website or webpage 306 generally runs on a remote webserver and may include various user interface elements to collect user information for registration or setup. Registration may generally entail enrolling in the tag-sharing program and acquiring at least the user's name and phone number to keep track of his tag-sharing activities. The setup may include the selection and change of the set of tags the user prefers to be included in his text or instant messages. It may also include various tagging policies similar to those described above with respect to the mobile device-side tag-sharing app. Those skilled in the art will appreciate that the tags may be included in any communication forum such as emails, social media pages like Facebook personal pages, and the like. The various functions and activities described herein may be divided appropriately between the webpage and the tag-sharing app as described above. All or some of the functions, such as setup, profile buildup and updates, image determination for tagging the next message, and the like may be implemented in one or both of these software depending on the state of technology, control and efficiency, and business considerations.

In some embodiments, the tag-sharing app and the webpage may be in communication, directly or indirectly, to exchange information such as the configuration of the user's account, user profile and activity history data, and tagging policies. The tag-sharing app may directly communicate with the webpage via the webserver to update local data and information, or communicate via the shared database 308 by reading and writing mutually accessible data fields. Hence, the user may select a new tag on his mobile device for inclusion in his text messages. This selection will be reflected in his account or configuration information on the webpage. Conversely, the user may select a logo or tagging policy on the webpage, which selections will appear and be applied shortly afterwards on his mobile device via the tag-sharing app.

In various embodiments, the sending of tagged messages may be automatically tracked by the system. This tracking may be used in order for the user to be awarded credits or tokens for sending tagged messages. The award of tokens may depend on various factors including the number of tagged messages send in total to present time, the rate of tagged messages sent per unit time, number of non-repeating recipients or repeating recipients, number of different types of tags (from different businesses) sent, number of repeated tags sent, and the like. In some embodiments, some tags may be worth more tokens than others. For example, for a first tag one credit or token may be awarded while for a second tag one and half credits may be awarded.

In various embodiments, to maintain an active status and receive credits (for sending tagged messages) in the tag-sharing program, the user may have to send a minimum number of tags per unit time. This minimum threshold for maintaining active status may be predetermined or may be set dynamically based on the user profile or history of activities. For example, a very active user may be assigned a lower active status threshold than another user who is less active. Credits may be awarded only to those users who maintain an active status in the tag-sharing program. The active status may be obtained or lost based on the rate of tagged message activities over a predetermined period of time. So, a user may lose his active status if he drops below the threshold for a certain amount of time and regain the status when he exceeds the threshold for another certain amount of time. In some embodiments, these time periods may be adjustable from zero to higher numbers.

In some embodiments, the credit or tokens may also have an expiration date before which the credit needs to be redeemed in terms of products, services, or monetary rewards. Once the expiration date of a given token is passed that token is expired. Tokens earned based on different criteria or based on different logos may have different expiration dates. The expiration date may further be adjustable based on the ranking of the user, as further described below. In some embodiments, the expiration date of the token is predetermined and provided to the user via the website or the tag-sharing app on the mobile device. In other embodiments, the expiration date of tokens may be determined dynamically based on user profile or activity levels. For example, for a more active user the expiration date of the tokens may be extended as a reward.

In various embodiments, the users may be assigned different levels or ranks by the tag-sharing app based on their profile and/or activities. As a user accumulates points at certain rate defined in terms of tagged messages sent per unit time, type of tags, and other considerations and factors similar to those used for awarding credits or tokens, the user may be assigned promotion points. When certain number of promotion points are accumulated for the user that exceed predetermined or dynamically determined promotion thresholds at each rank level, the user is promoted to the next rank. A higher rank comes with privileges such as lower thresholds for active status, higher reward rates, and the like. In some embodiments, the user may have to reach a promotion threshold several times within a limited to time to be promoted to a higher rank.

In various embodiments, the mobile device may use a GPS and other location-aware techniques that allow the tag-sharing app to tailor the tags, tokens, and points to the locality in which the user is most active. For example, when the user is in a locality that a commercial store chain is more active, the app may insert tags in the text messages that belong to local businesses. When the user moves to a different locality, such as when the user is on a trip, the app may sense the location and adjust the tags used accordingly.

In various embodiments, the user may be awarded additional promotion points and/or credits/tokens if he invites other users to join the tag-sharing program. In some embodiments, the messages are tagged by the tag-sharing app only when at least one of the recipients is in the list of sender's contacts. Accordingly, points and tokens are awarded only counting or considering the recipients that are in his contact list. In other embodiments, all recipients may be considered or counted for awards.

With continued reference to FIG. 3, in various embodiments, in operation, the user-sender may go to the website 306 and get enrolled in the tag-sharing program. The sender may they proceed to download the tag-sharing app to his mobile device. The user may also proceed to set up his tag-sharing account and select various award policies, images, and hotlinks. At this point, the user-sender may start a text message conversation with one or more users who are on his contact list. The tag-sharing app may tag one or more messages in the conversation according to one of the selected tagging policies described above. The recipient and/or the sender may click on the image or associated hotlink to download and view special offers of goods and services presented on a related website launched by the hotlink. The tag-sharing app may further add credits/tokens and/or promotion points to the sender's account for later redemption.

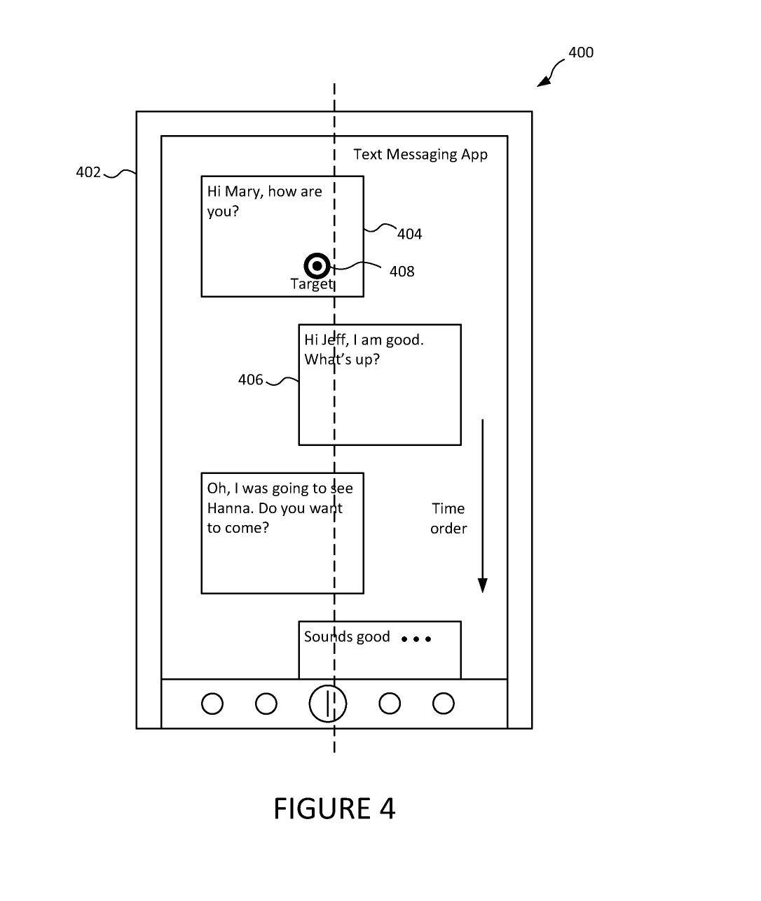

FIG. 4 shows an example mobile computing device with a text messaging application usable in the computing environment of FIG. 3. In various embodiments, text messaging conversation 400 may be carried out by a text messaging app executing on mobile computing device 402 that is substantially similar to the mobile computing device 304 of FIG. 3. The Text message conversation may include sending and receiving text messages 404 and 406, respectively, some of which may include an image 408.

In various embodiments, as described above, the tag-sharing app may insert an image 408 into one or more text messages in the conversation. In the example shown, the sender's text messages are shown towards the left side of the dotted line and the recipients responses are shown on the right side. In some embodiments, only the first message is tagged to avoid cluttering the messages with advertisements, while in other embodiments, tags may be inserted every few messages or every few minutes. In still other embodiments, the messages are tagged according to the tagging policy configured in the setup process, as described above with respect to FIG. 3.

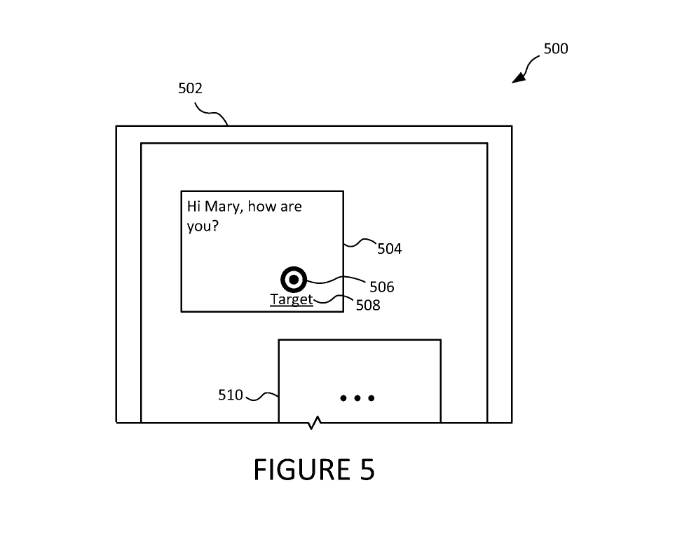

FIG. 5 shows an example message of the text messaging application of FIG. 4 tagged with an image and hotlink. In various embodiments, text message conversation 500 may take place on a computing device 502 and include an individual message 504 having an image 506 and associated text 508, which may be a hotlink, and response messages 510.

In various embodiments, the image 506 included in the text message 504 may be a hotlink itself or be associated with a hotlink in the form of a text segment, such as a business name or a phrase. When selected or clicked, the hotlink may load a webpage associated with the image to provide any type of information, including but not limited to special offers, coupons, or discount for goods or services offered by the image owner. Such offers may be based on the user's profile, including age, sex, purchase histories, circle of close friends and contacts as determined from frequency and length of messaging interactions, and the like.

In some embodiments, the tag-sharing app may change the hotlink to lead to different webpages and different information for different products and services depending on the recipient of the text message. More specifically, if the message recipient is a known user of the tag-sharing program and has a profile in the database, or is otherwise known, then the images and hotlinks send to him via text messages, the hotlink included in the sender's text message may be tailored to the preferences or history of the recipient. The tag-sharing app may acquire profile information from the database 308 (see FIG. 3) dynamically in real-time when the text message is being composed by the sender. In some embodiments, the tag-sharing app may tag the same message or successive messages with two or more images and hotlinks to increase the utilization of the messages in this respect.

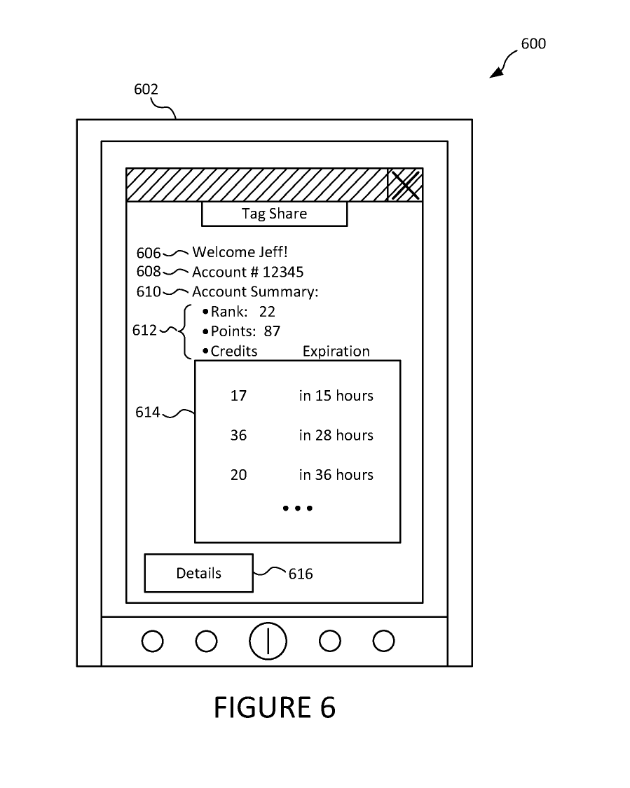

FIG. 6 shows an example tag sharing application on a mobile device configured to interact with a user and display the user's tag usage status. In various embodiments, the tag-sharing app 600 running on mobile device 620 may include an app window 604, user messages 606, account information 608, account summary 610, account rank and points 612, account credits or tokens' status 614, and button or link 616 for exposing further details about the above or obtaining further user inputs.

In various embodiments, the tag-sharing app 600 implements the functions discussed above with respect to FIG. 3. Specifically, the tag-sharing app may include or communicate with one or more separate software components for each of the functions in the system such as collecting data from the user, interacting with the database, setup, user profile creation and/or update, user account creation and/or update, tagging messages, user interface, tagging policy (as described herein) implementation, counting and accounting for points and credits/tokens, notification of user of various events such as promotions and credit awards, managing user promotion, and the like. Those skilled in the art will appreciate that one function may be implemented using multiple software modules or several functions may be implemented using one software module.

As noted above, in various embodiments, similar functions may be implemented and provided by the webpage 306 (see FIG. 3). The user may go to the webpage 306 to change the configuration and setup of his tag-sharing app, which will be reflected in and applied by the app later. Conversely, the user may change some preferences or data on his tag-sharing app on the mobile device and the changes will appear on the webpage thereafter.

It will be understood that in some embodiments, each step of the processes described above, and combinations of steps, may be implemented by computer program instructions. These program instructions may be provided to a processor to produce a machine, such that the instructions, which execute on the processor, enable implementing the actions specified. The computer program instructions may be executed by a processor to cause a series of operational steps to be performed by the processor to produce a computer implemented process such that the instructions, which execute on the processor to provide steps for implementing the actions. The computer program instructions may also cause at least some of the operational steps to be performed in parallel. Moreover, some of the steps may also be performed across more than one processor, such as might arise in a multi-processor computer system. In addition, one or more steps or combinations of steps described may also be performed concurrently with other steps or combinations of steps, or even in a different sequence than described without departing from the scope or spirit of the disclosure.

Accordingly, steps of processes or methods described support combinations of techniques for performing the specified actions, combinations of steps for performing the specified actions and program instruction for performing the specified actions. It will also be understood that each step, and combinations of steps described, can be implemented by special purpose hardware based systems which perform the specified actions or steps, or combinations of special purpose hardware and computer instructions.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

The embodiments of the invention in which an exclusive property or privilege is claimed are defined as follows:

1. A communication system comprising:
a computer network;
a mobile computing device coupled with the computer network having a tag-sharing app running thereon and configured to tag a message transmitted by the mobile computing device with an image and a hotlink to a webpage.

2. The communication system of claim 1, further comprising a database system coupled with the computer network.

3. The communication system of claim 1, further comprising a webserver coupled with the computer network.

4. The communication system of claim 1, wherein the tag-sharing app tags the message based on a tagging policy.

5. The communication system of claim 4, wherein the tagging policy comprises one of tagging a first message in a conversation, tagging a message after a predetermined number of messages are transmitted, and tagging a message after a predetermined number of time units has lapsed.

6. The communication system of claim 1, wherein a user of the mobile computing device is awarded credits based on a number of tagged messages the user sends per a predetermined time period.

7. The communication system of claim 1, wherein a user of the mobile computing device is awarded promotion points based on a number of tagged messages the user sends per a predetermined time period, and the user is promoted to a higher rank based on a number of awarded promotion points to acquire award credits at a faster rate than a lower rank.

8. The communication system of claim 7, wherein the award credits are associated with an expiration date.

9. A method of communication, the method comprising:
executing a tag-sharing app on a mobile computing device;
configuring the tag-sharing app to implement a tagging policy; and
applying the tagging policy by the tag-sharing app to tag an outgoing message from the mobile computing device with an image and a hotlink to a webpage to present information.

10. The method of communication of claim 9, further comprising interacting with a database to send and receive tag-sharing data.

11. The method of communication of claim 9, further comprising using a webpage in communication with the tag-sharing app to enter and view tag-sharing data.

12. The method of communication of claim 9, wherein the tagging policy comprises one of tagging a first message in a conversation, tagging a message after a predetermined number of messages are transmitted, and tagging a message after a predetermined number of time units has lapsed.

13. The method of communication of claim 9, wherein a user of the mobile computing device is awarded credits based on a number of tagged messages the user sends per a predetermined time period.

14. The method of communication of claim 9, wherein a user of the mobile computing device is awarded promotion points based on a number of tagged messages the user sends per a predetermined time period, and the user is promoted to a higher rank based on the number promotion points to acquire award credits at a faster rate than a lower rank.

15. The method of communication of claim 14, wherein the award credits are associated with an expiration date.

16. A method of tagging outgoing messages, the method comprising:
executing a tag-sharing app on a mobile computing device;
selecting a tag that includes an image and a hotlink;
configuring the tag-sharing app to implement a tagging policy to include the tag in an outgoing message; and
applying the tagging policy by the tag-sharing app to include the tag in the outgoing message from the mobile computing device.

17. The method of claim 16, further comprising creating and updating a user profile associated with a user of the mobile computing device.

18. The method of claim 16, wherein the tag is changed based on a recipient of a tagged message.

19. The method of claim 16, wherein tagged messages are sent only to recipients who are in a contact list of a user of the mobile computing device.

20. The method of claim 16, wherein the tag is selected from a schedule of tags, which is used to determine which tag is included in a next outgoing message.
